(19) United States
(12) Patent Application Publication
(10) Pub. No.: US 2015/0165977 A1
(43) Pub. Date: Jun. 18, 2015

(54) MODULAR FRONT VIEW MIRROR FOR VEHICLES

(71) Applicant: Shun-Fu Technology Corp., Taipei City (TW)

(72) Inventor: Yung-Sheng HUANG, Taipei City (TW)

(21) Appl. No.: 14/540,507

(22) Filed: Nov. 13, 2014

(30) Foreign Application Priority Data
Dec. 13, 2013 (TW) 102223569

(51) Int. Cl. B60R 1/10

(52) U.S. Cl. CPC B60R 1/10

(57) ABSTRACT

A modular vehicle front view mirror is disclosed. The modular vehicle front view mirror in accordance with an exemplary embodiment of the invention includes a main body having a box shape and including an incident side, a first reflecting side facing the incident side, a second reflecting side facing the first reflecting side and a watching side facing the second reflecting side; an incident window mounted to the incident side; a first reflecting mirror mounted to the first reflecting side; a second reflecting mirror mounted to the second reflecting side; and a watch window mounted to the watching side.

### BACKGROUND OF THE INVENTION

1. Field of the Invention

The invention relates to a modular vehicle front view mirror, and more particularly to a modular vehicle front view mirror assembled by a driver anytime and anywhere to watch traffic in front of the vehicle.

2. Description of the Related Art

Typically, rear view mirrors are disposed in an interior of a vehicle and two lateral side of the vehicle to watch traffic behind the vehicle so as to change lanes and flash the signal light.

The rear view mirror can only reflect the traffic behind the vehicle. However, the traffic in front of the vehicle cannot be watched by the rear view mirror. For example, when a vehicle is moving on a two-lane way and would like to overtake, drivers often watch rear view mirror to decide the time to overtake. Since the rear view mirror can only reflect the traffic behind the vehicle, drivers cannot watch all traffic in front of it and may hit other low-speed vehicles on the other lane in front of it when the vehicle changes to the other lane rapidly.

Although vehicles are often equipped with event data recorders or panoramic cameras to watch traffic in front of it, the event data recorders or panoramic cameras have a higher price and cables for the event data recorders or panoramic cameras occupy certain space to cause disorder of the interior.

Taiwan utility patent No. M447340 discloses a rear view mirror which can reflect the traffic in front of a vehicle. A reflecting mirror reflecting a front view of the vehicle is mounted within the rear view mirror so that drivers can watch the front and rear view with the rear view mirror at the same time. Since the reflecting mirror is mounted within the rear view mirror, the mounting must be performed by the manufacturer, and users cannot change the reflecting mirror's position.

### BRIEF SUMMARY OF THE INVENTION

The object of the invention is to provide a modular vehicle front view mirror which can be placed and positioned in any location by drivers.

To achieve the object, the invention provides a modular vehicle front view mirror. The modular vehicle front view mirror in accordance with an exemplary embodiment of the invention includes a main body having a box shape and including an incident side, a first reflecting side facing the incident side, a second reflecting side facing the first reflecting side and a watching side facing the second reflecting side; an incident window mounted to the incident side; a first reflecting mirror mounted to the first reflecting side; a second reflecting mirror mounted to the second reflecting side; and a watch window mounted to the watching side.

In another exemplary embodiment, the main body further includes a top cover and a bottom cover, and the incident side, the first reflecting side, the second reflecting side and the watching side are disposed between the top cover and the bottom cover.

In yet another exemplary embodiment, the incident side, the first reflecting side, the second reflecting side and the watching side have grooves to hold and position the incident window, the first reflecting mirror, the second reflecting mirror and the watch window.

In another exemplary embodiment, the top cover and the bottom cover have positioning members disposed near edges of the top cover and the bottom cover.

In yet another exemplary embodiment, the main body further includes an extension side disposed between the first reflecting side and the watching side.

In another exemplary embodiment, the first reflecting mirror is a convex mirror, and the second reflecting mirror is a flat mirror.

In yet another exemplary embodiment, the first reflecting mirror and the second reflecting mirror further comprise angle adjusting devices.

In another exemplary embodiment, the modular vehicle front view mirror further includes a convex lens disposed between the second reflecting mirror and the watching side.

In yet another exemplary embodiment, the first reflecting mirror, the second reflecting mirror and the convex lens includes angle adjusting devices.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of a modular vehicle front view mirror of the invention;

FIG. 2 is a exploded perspective view of FIG. 1;

FIG. 3 is front view of an embodiment of a modular vehicle front view mirror of the invention;

FIG. 4 is a top view of an embodiment of a modular vehicle front view mirror of the invention;

FIG. 5 is a schematic view of another embodiment of a modular vehicle front view mirror of the invention; and

FIG. 6 depicts a modular vehicle front view mirror of the invention disposed in a vehicle.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

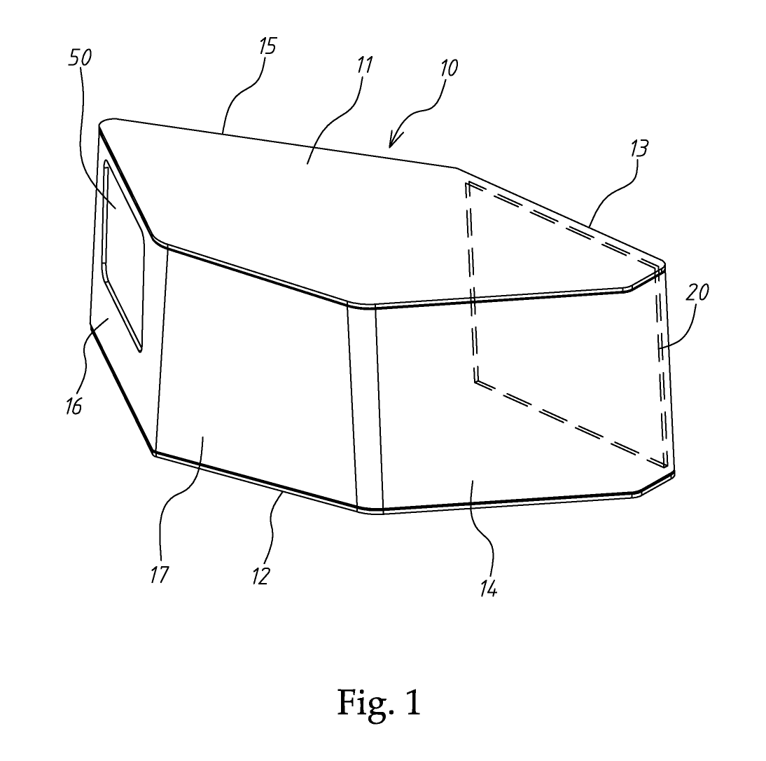

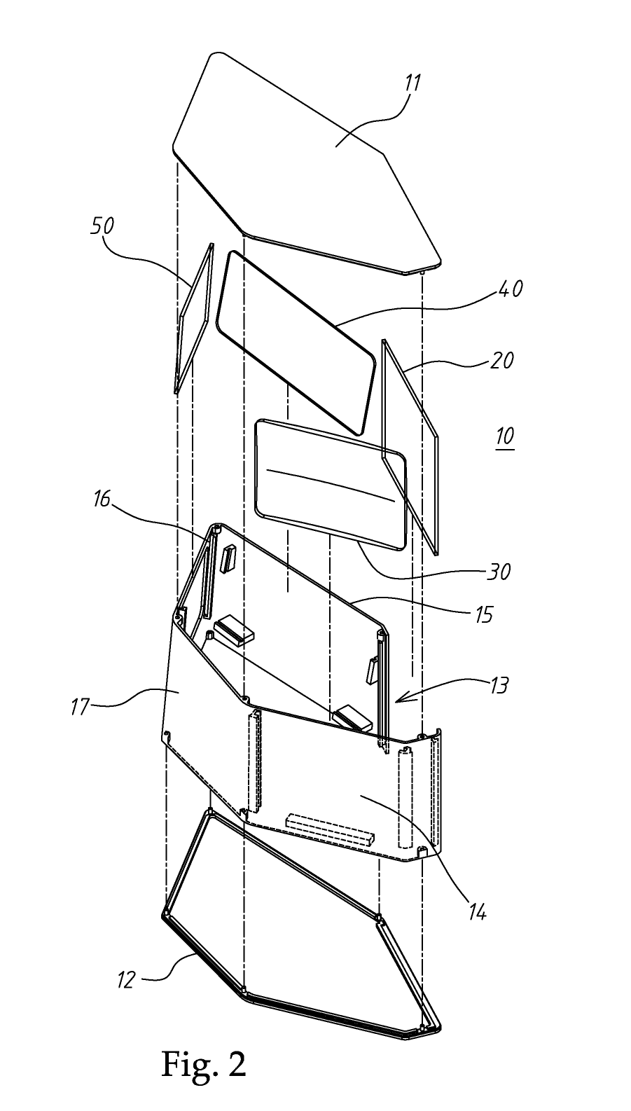

Referring to FIGS. 1 to 3, a modular vehicle front view mirror includes a main body 10. In this embodiment, the main body 10 has a box shape and includes a top cover 11, a bottom cover 12 and a plurality of sides. The main body 10 can be positioned in any position in the vehicle based on drivers' requirement.

The plurality of sides include an incident side 13, a first reflecting side 14 facing the incident side 13, a second reflecting side 15 facing the first reflecting side 14, and a watching side 16 facing the second reflecting side 15. In this embodiment, The plurality of sides further include an extension side 17 disposed between the first reflecting side 14 and the watching side 16 to obtain a proper incident angle and reflect angle.

An incident window 20 made of optical transparent material is mounted to the incident side 13. A first reflecting mirror 30 is mounted to an inner surface of the first reflecting side 14. A second reflecting mirror 40 is mounted to an inner surface of the second reflecting side 15. A watching window 50 made of optical transparent material is mounted to the watching side 16. To obtain a larger view angle and a reflect angle, the first reflecting mirror 30 is a convex mirror, and the second reflecting mirror 40 is a flat mirror.

In this embodiment, the incident side 13, the first reflecting side 14, the second reflecting side 15 and the watching side 16 have grooves formed on inner surfaces thereof to hold and position the incident window 20, the first reflecting mirror 30, the second reflecting mirror 40 and the watching window 50 respectively. The top cover 11 and the bottom cover 12 have positioning member disposed near edges thereof The positioning members can be grooves or walls cooperating with the grooves formed on the incident side 13, the first reflecting side 14, the second reflecting side 15 and the watching side 16 to constitute the main body 10. The positioning members above is only an example for description, but not to limit the invention.

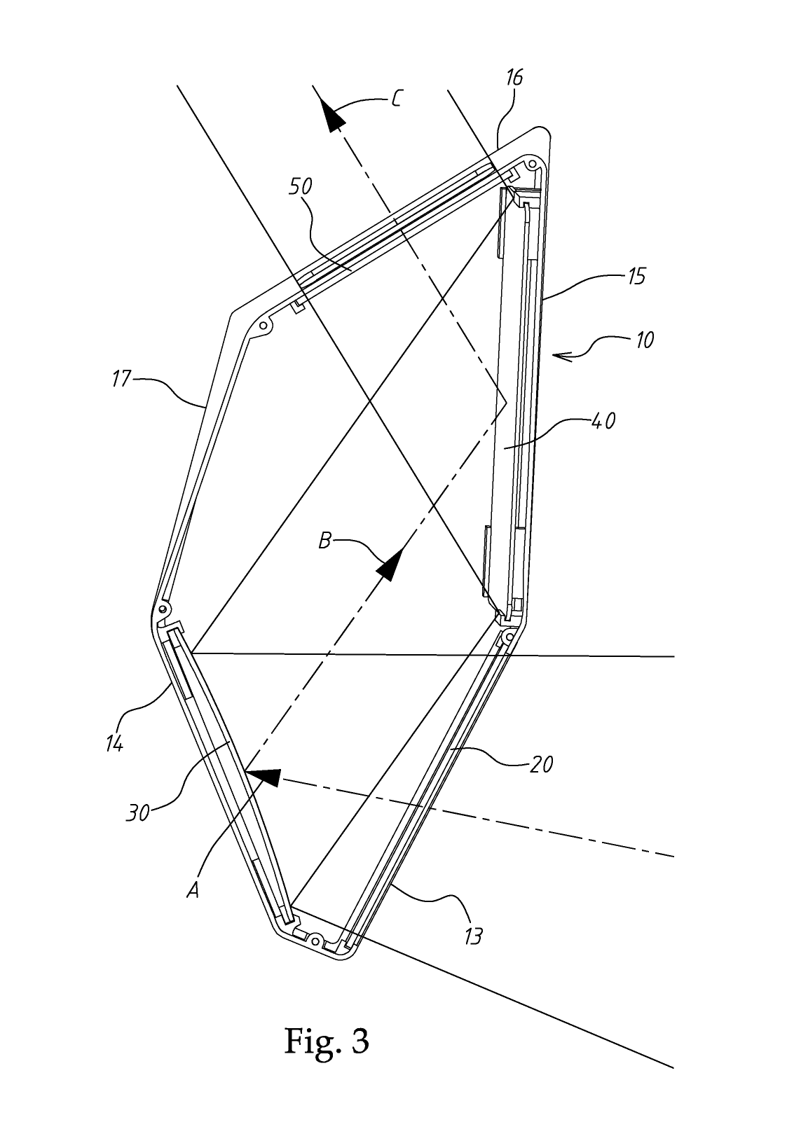

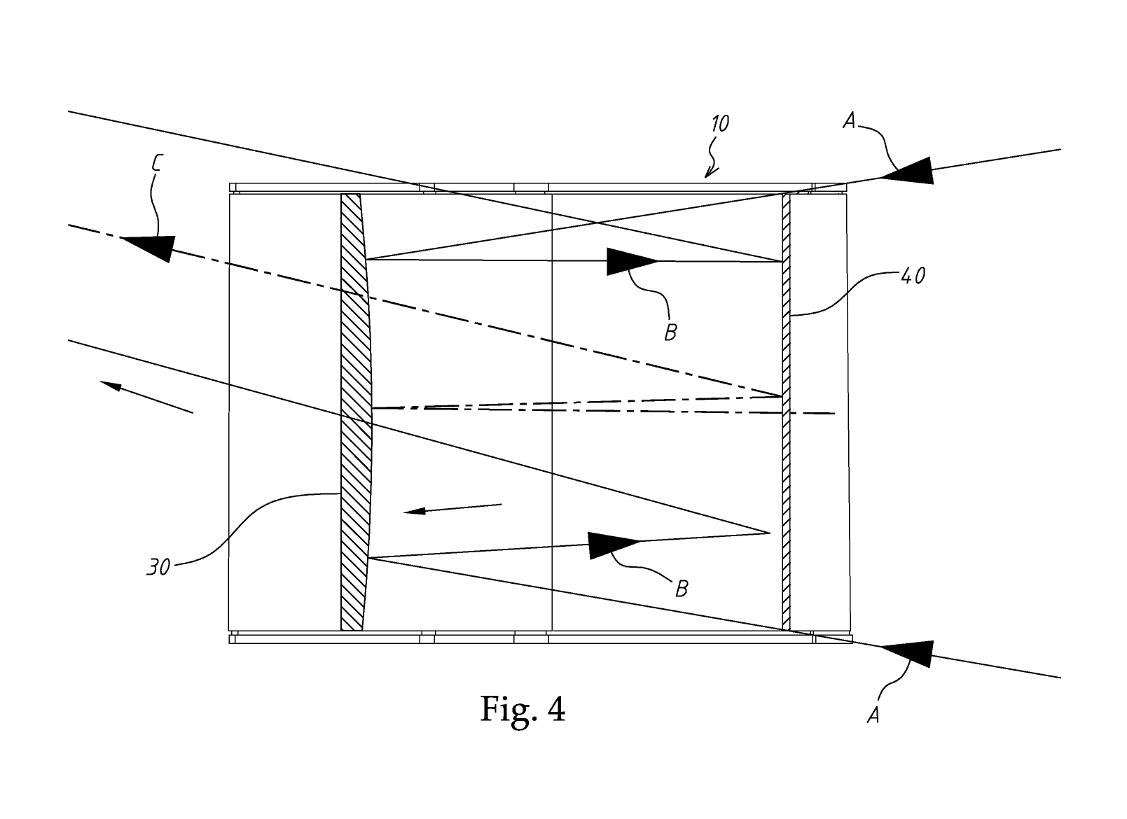

Referring to FIGS. 3 and 4, when the modular vehicle front view mirror is positioned in a vehicle, the incident side 13 and the incident window 20 face the front of the vehicle with an inclined angle. Light from the front of the vehicle passes through the incident window 20 to enter the main body 10. The incident light shown by an arrow A is reflected by the first reflecting mirror 30, the reflected light shown by an arrow B is reflected by the second reflecting mirror 40. The light reflected by the second reflecting mirror 40 (shown by an arrow C) passes through the watching window 50 and is viewed by a driver. Thus, the driver can watch the traffic in front of the vehicle clearly.

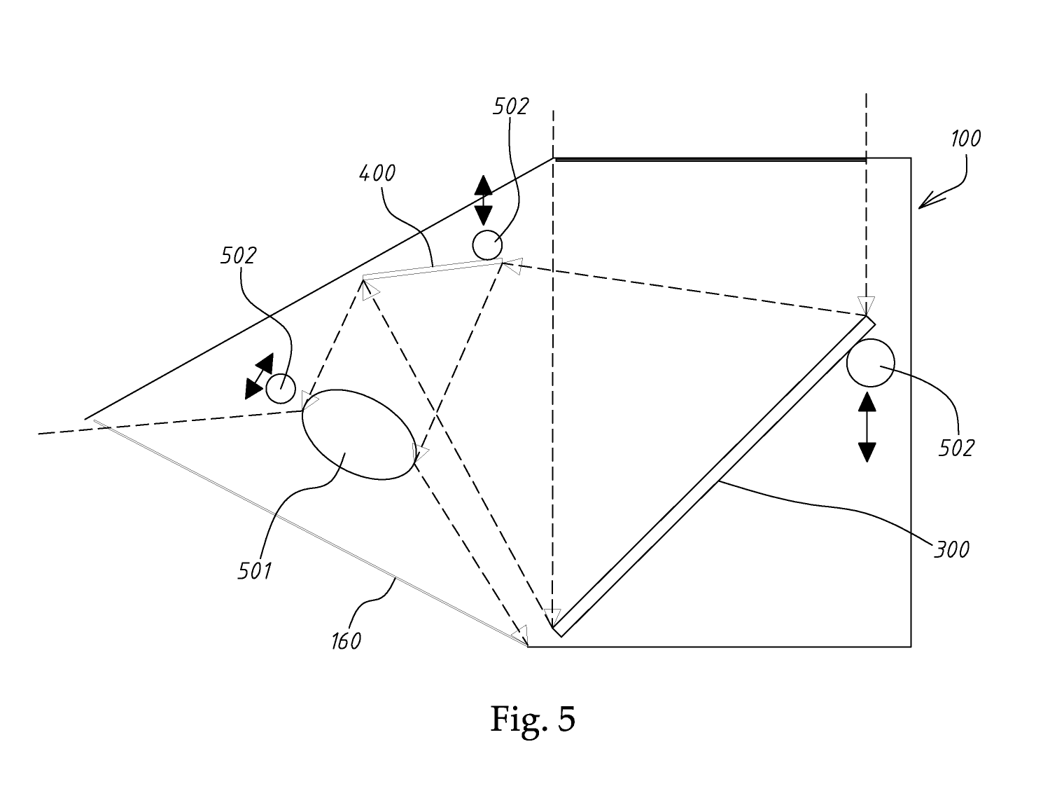

Referring to FIG. 5, another embodiment of a modular vehicle front view mirror is disclosed. The modular vehicle front view mirror of this embodiment includes a main body 100, a first reflecting mirror 300, a second reflecting mirror 400 and a convex lens 501. The main body 100 includes a watching side 160, and the convex lens 501 is disposed between the watching side 160 and the second reflecting mirror 400. Angle adjusting devices 502 are disposed near the first reflecting mirror 300, the second reflecting mirror 400 and the convex lens 501 to adjust the incident and reflect angle.

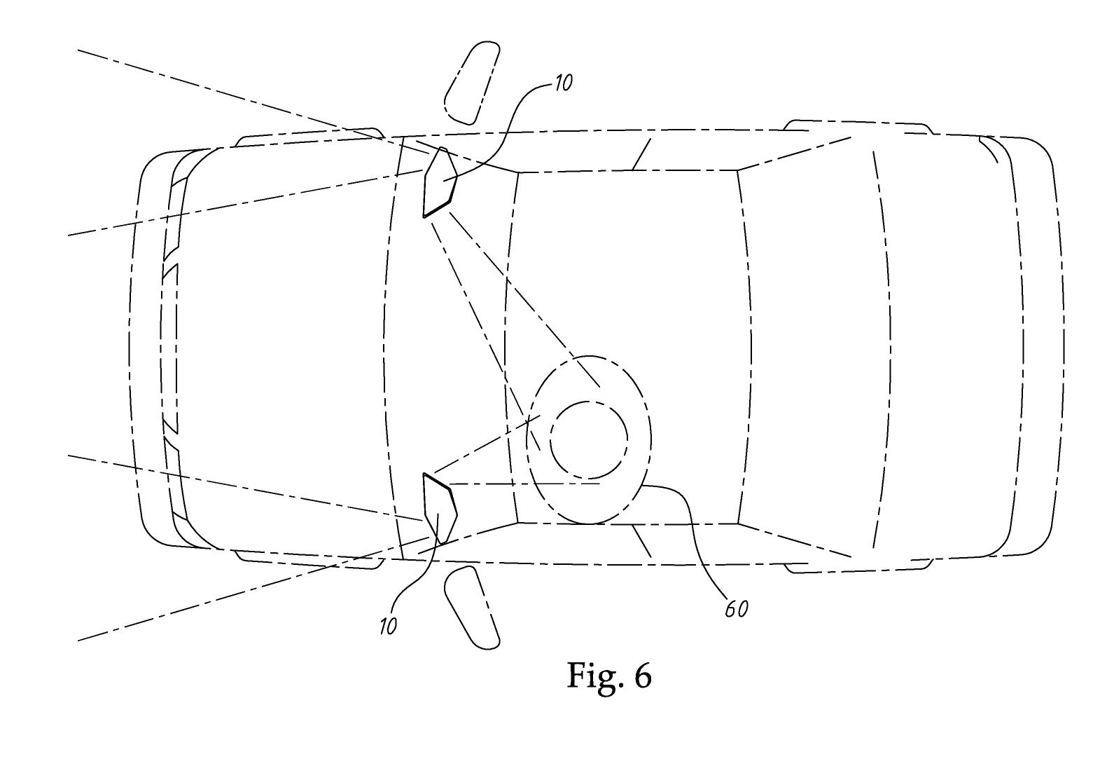

Referring to FIG. 6, the modular vehicle front view mirror of the invention can be placed on the side of a vehicle that the driver is seated for right-hand drive vehicles or left-hand drive vehicles to watch the view in front of the vehicle.

The modular vehicle front view mirror can be placed in any position of a vehicle according to drivers' requirement to watch the traffic in front of the vehicle and ensure traffic safety.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A modular vehicle front view mirror, comprising:
a main body having a box shape and comprising an incident side, a first reflecting side facing the incident side, a second reflecting side facing the first reflecting side and a watching side facing the second reflecting side;
an incident window mounted to the incident side;
a first reflecting mirror mounted to the first reflecting side;
a second reflecting mirror mounted to the second reflecting side; and
a watch window mounted to the watching side.

2. The modular vehicle front view mirror as claimed in claim 1, wherein the main body further comprises a top cover and a bottom cover, and the incident side, the first reflecting side, the second reflecting side and the watching side are disposed between the top cover and the bottom cover.

3. The modular vehicle front view mirror as claimed in claim 1, wherein the incident side, the first reflecting side, the second reflecting side and the watching side have grooves to hold and position the incident window, the first reflecting mirror, the second reflecting mirror and the watch window.

4. The modular vehicle front view mirror as claimed in claim 2, wherein the top cover and the bottom cover have positioning members disposed near edges of the top cover and the bottom cover.

5. The modular vehicle front view mirror as claimed in claim 2, wherein the main body further comprises an extension side disposed between the first reflecting side and the watching side.

6. The modular vehicle front view mirror as claimed in claim 1, wherein the first reflecting mirror is a convex mirror, and the second reflecting mirror is a flat mirror.

7. The modular vehicle front view mirror as claimed in claim 2, wherein the first reflecting mirror is a convex mirror, and the second reflecting mirror is a flat mirror.

8. The modular vehicle front view mirror as claimed in claim 3, wherein the first reflecting mirror is a convex mirror, and the second reflecting mirror is a flat mirror.

9. The modular vehicle front view mirror as claimed in claim 4, wherein the first reflecting mirror is a convex mirror, and the second reflecting mirror is a flat mirror.

10. The modular vehicle front view mirror as claimed in claim 5, wherein the first reflecting mirror is a convex mirror, and the second reflecting mirror is a flat mirror.

11. The modular vehicle front view mirror as claimed in claim 1, wherein the first reflecting mirror and the second reflecting mirror further comprise angle adjusting devices.

12. The modular vehicle front view mirror as claimed in claim 1 further comprising a convex lens disposed between the second reflecting mirror and the watching side.

13. The modular vehicle front view mirror as claimed in claim 6 further comprising a convex lens disposed between the second reflecting mirror and the watching side.

14. The modular vehicle front view mirror as claimed in claim 1, wherein the first reflecting mirror, the second reflecting mirror and the convex lens comprise angle adjusting devices.
